(19) United States
(12) Patent Application Publication
(10) Pub. No.: US 2026/0255119 A1
(43) Pub. Date: Aug. 27, 2026

(54) METHODS AND APPARATUSES FOR MANIPULATION OF IMMERSIVE AUDIO SCENES

(71) Applicant: DOLBY INTERNATIONAL AB, Dublin (IE)

(72) Inventors: Kurt Krauss, Feucht (DE); Christof Joseph Fersch, Neumarkt (DE)

(73) Assignee: DOLBY INTERNATIONAL AB, Dublin (IE)

(21) Appl. No.: 19/161,662

(22) PCT Filed: Mar. 1, 2024
(86) PCT No.: PCT/EP2024/055399

§ 371 Date: Sep. 2, 2025

Related U.S. Application Data
(60) Provisional application No. 63/449,688, filed on Mar. 3, 2023.
(60) Provisional application No. 63/556,307, filed on Feb. 21, 2024.

(30) Foreign Application Priority Data
Mar. 3, 2023 (EP) 23160031.3

(51) Int. Cl. H04S 7/00

(52) U.S. Cl. CPC H04S 7/30; H04S 2400/11

(57) ABSTRACT

Described herein is a method of processing a 3D audio scene, including: receiving an original 3D audio scene, the original 3D audio scene including first audio data and first metadata for a plurality of first audio elements in 3D audio space; receiving information indicative of modifying the original 3D audio scene; obtaining one or more rendering parameters from the information; and rendering the original 3D audio scene based on the one or more rendering parameters to obtain a modified 3D audio scene. Further described are alternative methods of processing a 3D audio scene, as well as corresponding apparatuses and computer program products.

### TECHNICAL FIELD

The present disclosure relates generally to methods of processing 3D audio scenes. In particular, an original 3D audio scene including first audio elements in 3D audio space may be modified. Second audio elements may be jointly rendered with the modified audio scene or the original 3D audio scene. The present disclosure further relates to corresponding apparatuses and computer program products.

While some embodiments will be described herein with particular reference to that disclosure, it will be appreciated that the present disclosure is not limited to such a field of use and is applicable in broader contexts.

### BACKGROUND

Any discussion of the background art throughout the disclosure should in no way be considered as an admission that such art is widely known or forms part of common general knowledge in the field.

In virtual or augmented viewing environments (Augmented Reality (AR), Mixed Reality (MR), Extended Reality (XR)), AR glasses are a prominent example, placement of audio elements for personalized advertisement or information purposes in other contexts, becomes more and more important. Immersive audio, however, can have a detrimental impact on the attention of the viewer/listener and their ability to focus on tasks and details. In virtual or augmented viewing environments, the placement of audio elements in a complex rendered scene may even lead to temporary confusion.

There is thus need for enabling modification of an original immersive rendered audio scene in a controlled manner. There is further need for enabling intelligent placement of audio elements in immersive rendered audio scenes.

### SUMMARY

In accordance with a first aspect of the present disclosure there is provided a method of processing a 3D audio scene. The method may include receiving an original 3D audio scene. The original 3D audio scene may include first audio data and first metadata for a plurality of first audio elements in 3D audio space. The method may further include receiving second audio data and second metadata for one or more second audio elements. The method may further include extracting one or more rendering parameters from the second metadata for rendering the one or more second audio elements relative to the original 3D audio scene. The method may further include modifying the original 3D audio scene to obtain a modified 3D audio scene. And the method may include jointly rendering the one or more second audio elements and the modified 3D audio scene based on the one or more rendering parameters.

Accordingly, the original audio scene can be modified in a controlled manner to provide room for the second audio elements (guest audio elements). This allows joint rendering of the original audio scene and the guest audio elements in a meaningful way, based on environmental conditions and/or content context, avoiding detrimental or even annoying effects for the listener.

In some embodiments, modifying the original 3D audio scene may be based on the metadata.

In some embodiments, the original 3D audio scene may be associated with a first spatial volume that encloses the plurality of first audio elements. Modifying the original 3D audio scene may include mapping the first spatial volume to a second spatial volume associated with the modified 3D audio scene. The second spatial volume may be a modified spatial volume compared to the first spatial volume.

In some embodiments, the modified spatial volume may be a reduced spatial volume. Optionally, a volume fraction of the reduced spatial volume associated with the modified 3D audio scene may be of from 1% to 99% with respect to the first spatial volume.

In some embodiments, the modified spatial volume may be an extended spatial volume. Optionally, a volume fraction of the extended spatial volume associated with the modified 3D audio scene may be of from 101% to 300% with respect to the first spatial volume.

In some embodiments, the first metadata may include first tagging information for the plurality of first audio elements indicating whether respective first audio elements are to be moved in 3D audio space when mapping the first spatial volume to the second spatial volume. Therein, only first audio elements that are indicated by the first tagging information as not to be moved may be rendered at their original positions.

In some embodiments, mapping the first spatial volume to the second spatial volume may be performed instantaneously.

In some embodiments, mapping the first spatial volume to the second spatial volume may be performed gradually or stepwise over time.

In some embodiments, modifying the original 3D audio scene further may include selecting a third spatial volume in the 3D audio space for allocating the one or more second audio elements.

In some embodiments, the third spatial volume may be at least partly overlapping with the first spatial volume.

In some embodiments, mapping the first spatial volume to the second spatial volume may include removing respective first audio elements from the third spatial volume. Therein, only first audio elements that are indicated by the first tagging information as not to be moved may not be removed from the third spatial volume.

In some embodiments, removing the first audio elements from the third spatial volume may be performed instantaneously.

In some embodiments, removing the first audio elements from the third spatial volume may be performed gradually or stepwise over time.

In some embodiments, jointly rendering the one or more second audio elements and the modified 3D audio scene may include rendering the one or more second audio elements within the third spatial volume and rendering the modified 3D audio scene within the second spatial volume.

In some embodiments, a shape of the first, the second, and/or the third spatial volume may include one or more of a sphere, a quadrant, an octant, and a point.

In some embodiments, the shape of the first, the second, and/or the third spatial volume may be based on the metadata.

In some embodiments, the shape of the first, the second, and/or the third spatial volume may be predefined.

In some embodiments, the modifying the original 3D audio scene and/or the joint rendering may be based on first timing information, the first timing information indicating a point in time or a time period for applying said modifying and/or said joint rendering.

In some embodiments, the method further may include, following the joint rendering, removing the one or more second audio elements and returning to rendering the original 3D audio scene.

In some embodiments, the removing the one or more second audio elements and/or the returning to the rendering of the original 3D audio scene may be based on second timing information, the second timing information indicating a point in time or a time period for applying said removing and/or said returning.

In some embodiments, the second metadata may include second tagging information for the one or more second audio elements indicating whether respective second audio elements are to be removed when returning to the rendering of the original 3D audio scene. Therein, only second audio elements that are indicated by the second tagging information as not to be removed may not be removed prior to the rendering of the original 3D audio scene.

In some embodiments, the one or more rendering parameters may include an indication of a loudness of the one or more second audio elements. Therein, the joint rendering may further include adjusting the loudness of the one or more second audio elements relative to a loudness of the modified 3D audio scene.

In some embodiments, the joint rendering may further include adapting a gain of the modified 3D audio scene and/or of the one or more second audio elements.

In some embodiments, the method may include receiving different versions of the second audio data for the one or more second audio elements, each version having a different audio configuration.

In some embodiments, the method may further include selecting a version of the second audio data for the one or more second audio elements that best matches the audio configuration of the original 3D audio scene.

In some embodiments, the joint rendering may further include aligning the audio configurations of the one or more second audio elements and the modified 3D audio scene.

In some embodiments, the one or more rendering parameters may further include an indication of a perceived complexity of the one or more second audio elements.

In some embodiments, the one or more rendering parameters may further include an indication of a sensitivity with respect to a perceived interference of the one or more second audio elements by other audio elements.

In some embodiments, the one or more rendering parameters may further include an indication of an audio quality of the one or more second audio elements.

In some embodiments, the method may further include, prior to the joint rendering, comparing the audio quality of the one or more second audio elements to an audio quality of the original 3D audio scene and aligning the audio quality of the one or more second audio elements with the audio quality of the original 3D audio scene.

In some embodiments, the one or more rendering parameters may further include an indication of a priority level for each of the one or more second audio elements, the priority level indicating a priority for rendering a respective second audio element.

In some embodiments, the joint rendering may further include modifying some or all of the first audio elements based on the respective priority levels.

In some embodiments, the one or more rendering parameters may further include an indication of a category for each of the one or more second audio elements, the category including one or more of optional, mandatory, supplemental, emergency, dependent on, depending on, in context of the original 3D audio scene and out of context of the original 3D audio scene.

In some embodiments, the joint rendering may be based on the perceived complexity and/or the sensitivity of the original 3D audio scene and optionally be based on the indication of the perceived complexity and/or the indication of the sensitivity of the one or more second audio elements.

In some embodiments, the joint rendering may be based on the indication of the priority level and the indication of the category of each of the one or more second audio elements, disregarding the perceived complexity and the sensitivity of the original 3D audio scene.

In some embodiments, the selecting the third spatial volume or a prioritizing of the allocating of the one or more second audio elements to the third spatial volume may be based on one or more of the indication of the perceived complexity, the sensitivity, the audio quality, the priority level and the category of the one or more second audio elements.

In some embodiments, a first audio element of the original 3D audio scene relating to ambience within the third spatial volume may be left unmodified and the joint rendering may include attenuating or amplifying the one or more second audio elements relative to the first audio element relating to ambience.

In accordance with a second aspect of the present disclosure there is provided a method of processing a 3D audio scene. The method may include receiving an original 3D audio scene, the original 3D audio scene including first audio data and first metadata for a plurality of first audio elements in 3D audio space. The method may further include receiving second audio data and second metadata for one or more second audio elements. The method may further include extracting one or more rendering parameters from the second metadata for rendering the one or more second audio elements within the original 3D audio scene. And the method may include jointly rendering the one or more second audio elements and the original 3D audio scene based on the one or more rendering parameters.

In some embodiments, the joint rendering may include embedding the one or more second audio elements into the original 3D audio scene such that the original 3D audio scene may be augmented by the one or more second audio elements.

In some embodiments, the joint rendering may include modifying some or all of the first audio elements based on the one or more rendering parameters.

In accordance with a third aspect of the present disclosure there is provided a method of processing a 3D audio scene. The method may include receiving an original 3D audio scene, the original 3D audio scene including audio data and metadata for a plurality of first audio elements in 3D audio space. The method may further include receiving information indicative of modifying the original 3D audio scene. The method may further include obtaining one or more rendering parameters from the information. And the method may include rendering the original 3D audio scene based on the one or more rendering parameters to obtain a modified 3D audio scene.

In some embodiments, the information may correspond to default metadata associated with one or more default audio elements.

In some embodiments, the information may be real-time generated information.

In some embodiments, the information may be based on user preferences and/or location data.

In accordance with a fourth aspect of the present disclosure there is provided an apparatus for processing an audio scene. The apparatus may include one or more processors configured to carry out the methods described herein. In one implementation, the one or more processors may be configured for carrying out a method including receiving an original 3D audio scene, the original 3D audio scene including first audio data and first metadata for a plurality of first audio elements in 3D audio space; receiving second audio data and second metadata for one or more second audio elements; extracting one or more rendering parameters from the second metadata for rendering the second audio elements relative to the original 3D audio scene; modifying the original 3D audio scene to obtain a modified 3D audio scene; and jointly rendering the one or more second audio elements and the modified 3D audio scene based on the one or more rendering parameters.

In some embodiments, the one or more processors may further be configured to remove, after the joint rendering, the one or more second audio elements and to return to rendering the original 3D audio scene.

In accordance with a fifth aspect of the present disclosure there is provided an apparatus for processing an audio scene. The apparatus may include one or more processors configured to carry out a method including receiving an original 3D audio scene, the original 3D audio scene including first audio data and first metadata for a plurality of first audio elements in 3D audio space; receiving second audio data and second metadata for one or more second audio elements; extracting one or more rendering parameters from the second metadata for rendering the one or more second audio elements within the original 3D audio scene; and jointly rendering the one or more second audio elements and the original 3D audio scene based on the one or more rendering parameters.

In accordance with a sixth aspect of the present disclosure there is provided an apparatus for processing an audio scene. The apparatus may include one or more processors configured to carry out a method including receiving an original 3D audio scene, the original 3D audio scene including audio data and metadata for a plurality of first audio elements in 3D audio space; receiving information indicative of modifying the original 3D audio scene; obtaining one or more rendering parameters from the information; and rendering the original 3D audio scene based on the one or more rendering parameters to obtain a modified 3D audio scene.

In accordance with a seventh aspect of the present disclosure there is provided a program comprising instructions that, when executed by a processor, cause the processor to carry out the methods described herein. The program may be stored on a computer-readable storage medium.

It will be appreciated that apparatus (system) features and method steps may be interchanged in many ways. In particular, the details of the disclosed method(s) can be realized by the corresponding apparatus (system), and vice versa, as the skilled person will appreciate.

Moreover, any of the above statements made with respect to the method(s) are understood to likewise apply to the corresponding apparatus (system), and vice versa.

### BRIEF DESCRIPTION OF THE DRAWINGS

Example embodiments of the disclosure will now be described, by way of example only, with reference to the accompanying drawings in which:

FIG. 1 illustrates a first example of a method of processing a 3D audio scene according to an embodiment of the disclosure.

FIG. 2 illustrates a schematic of an example of modifying an original 3D audio scene to obtain a modified 3D audio scene and jointly rendering second audio elements and the modified 3D audio scene according to an embodiment of the disclosure.

FIG. 3 illustrates a schematic of a further example of modifying an original 3D audio scene to obtain a modified 3D audio scene and jointly rendering second audio elements and the modified 3D audio scene according to an embodiment of the disclosure.

FIG. 4 illustrates a schematic of a further example of modifying an original 3D audio scene to obtain a modified 3D audio scene and jointly rendering second audio elements and the modified 3D audio scene according to an embodiment of the disclosure.

FIG. 5 illustrates a second example of a method of processing a 3D audio scene according to an embodiment of the disclosure.

FIG. 6 illustrates a schematic of an example of jointly rendering second audio elements and an original 3D audio scene according to an embodiment of the disclosure.

FIG. 7 illustrates a third example of a method of processing a 3D audio scene according to an embodiment of the disclosure.

FIG. 8 illustrates a schematic of an example of modifying an original 3D audio scene to obtain a modified 3D audio scene according to an embodiment of the disclosure.

FIG. 9 illustrates a schematic of a further example of modifying an original 3D audio scene to obtain a modified 3D audio scene according to an embodiment of the disclosure.

FIG. 10 illustrates schematically an example of an apparatus for implementing methods according to embodiments of the disclosure.

### DESCRIPTION OF EXAMPLE EMBODIMENTS

### Overview

Methods and apparatuses as described herein enable immersive audio renderers to purposefully modify, shape or collapse a rendered sound field, so that based on environmental conditions, user preferences and/or content context, different goals may be achieved. These goals may be:
To reduce distraction induced by spatial audio rendering which may have a detrimental effect on the viewer in certain scenarios, for example when listening to an augmented (AR) sound field when walking through traffic;
To ‘make space’ for other pieces of content, such as audio with a different context, that are being added to an already existing immersive scene, for example to increase the presence of an advertisement added to augment an existing rendered audio environment;
To steer attention of a listener by manipulation (modification) of an immersive rendered scene to highlights of the scene, for example for training purposes.
To improve the intelligibility of the immersive scene for users with specific sensory impairments or sensory preferences

Methods and apparatuses as described herein provide the means to permanently or temporarily influence and manipulate an original immersive rendered audio scene in a way so that the attention or focus of the user can be steered by intelligent placement of audio sources (e.g., audio elements or audio objects). An audio scene may be understood as group of audio elements in 3D space, each having specific audio characteristics, e.g. loudness and direction, and an associated audio signal.

Methods and apparatuses as described herein further provide the capability to scale the modification, e.g., collapsing, of an original audio scene from a minimum (not manipulated/modified) to a selected maximum. For example, the entire original audio scene may be folded (mapped, collapsed) to a single (mono) point in 3D audio space or downmix, or the entire original audio scene may be extended to a maximum in 3D audio space.

Additionally, specific elements in the 3D audio space may be modified, to be less audible, more audible or to produce a specific spatial effect such as a focus on audio elements in the viewing direction of a user.

### Methods and Apparatuses of Processing a 3D Audio Scene

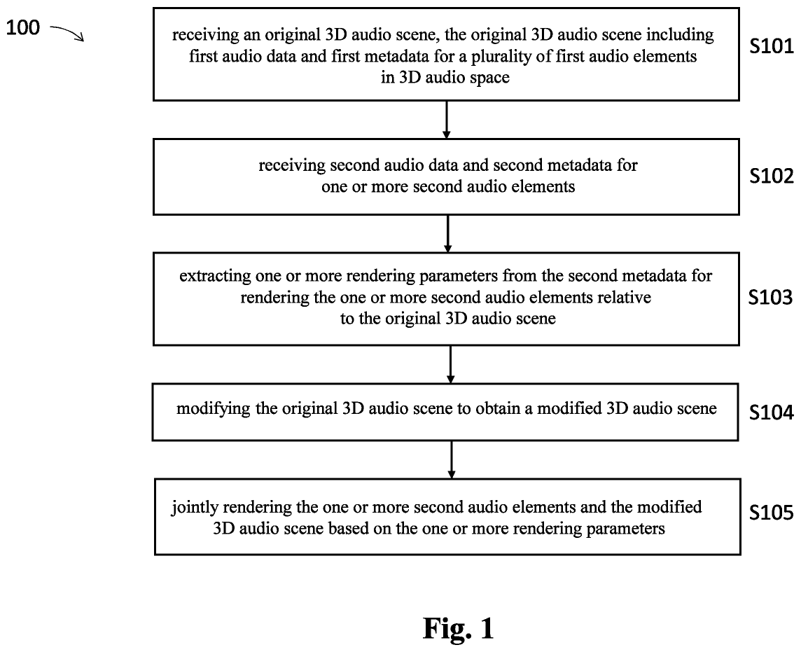

Referring to FIG. 1, a first example of a method of processing a 3D audio scene 100 is illustrated.

In step S101, an original 3D audio scene is received. The original 3D audio scene includes first audio data and first metadata for a plurality of first audio elements in 3D audio space. The original 3D audio scene may be an original immersive rendered 3D audio scene or, in other words, the original 3D audio scene may be said to be an original rendered sound field in 3D audio space.

In step S102, second audio data and second metadata for one or more second audio elements are received. The second audio data/second audio elements may represent pieces of content other than the first audio data/first audio elements with a different context such as, for example, advertisement or emergency context.

In step S103, one or more rendering parameters are extracted from the second metadata for rendering the one or more second audio elements relative to the original 3D audio scene. The one or more rendering parameters may allow, for example, to steer attention or focus of the user/listener. Examples of the properties/characteristics of the one or more rendering parameters are described below in more detail.

In step S104, the original 3D audio scene is modified (or manipulated) to obtain a modified 3D audio scene. Modifying the original 3D audio scene may allow to temporarily or permanently shape the original 3D audio scene. The modification may allow to control/steer the placement/rendering of the second audio elements in relation to the modified 3D audio scene. In an embodiment, modifying the original 3D audio scene may thus be based on the metadata.

In step S105, the one or more second audio elements and the modified 3D audio scene are then jointly rendered based on the one or more rendering parameters.

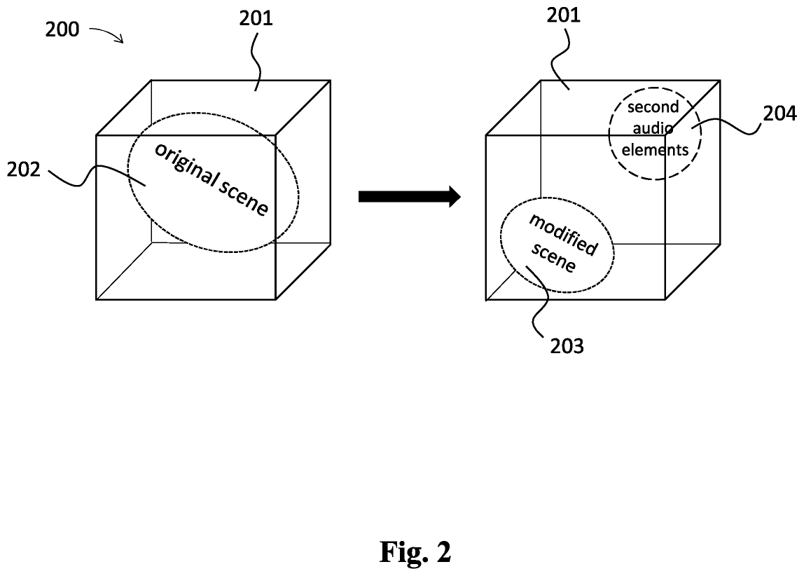

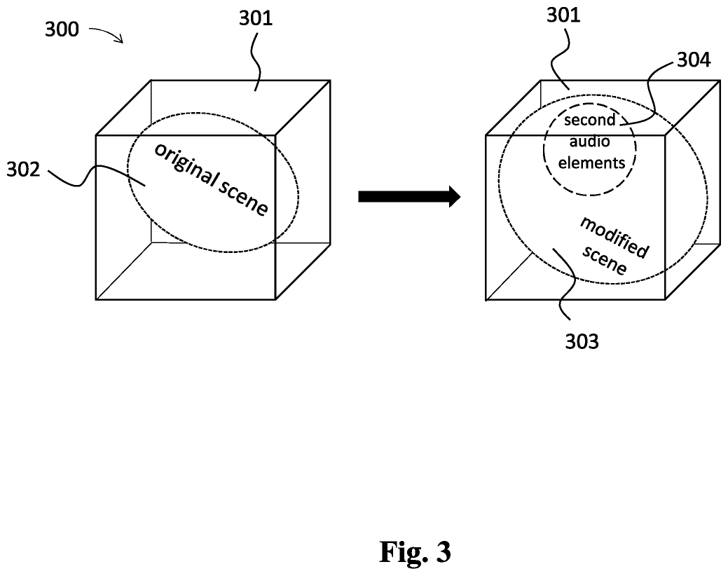

Modifying the original 3D audio scene may be said to make space for rendering the one or more second audio elements. This may be realized by collapsing or extending the original 3D audio scene as illustrated in the examples of FIG. 2 and FIG. 3. Both examples illustrate schematics of an example of modifying an original 3D audio scene 200, 300 to obtain a modified 3D audio scene and jointly rendering second audio elements and the modified 3D audio scene. Both examples illustrate, as a ‘starting point’, an original 3D audio scene in 3D audio space 201, 301. In the examples of FIGS. 2 and 3, the original 3D audio scenes are illustrated to be associated with a respective (first) spatial volume 202, 302. This first spatial volume 202, 302 may enclose a respective plurality of first audio elements which are not illustrated for reasons of simplicity.

In an embodiment, modifying said original 3D audio scene may include mapping the first spatial volume to a second spatial volume associated with the modified 3D audio scene, where the second spatial volume is a modified spatial volume compared to the first spatial volume. As already described above, modifying the original 3D audio scene may be realized by collapsing or extending the original 3D audio scene, depending on circumstances.

The example of FIG. 2 illustrates collapsing the original 3D audio scene by mapping the first spatial volume 202 to a second spatial volume 203 associated with the modified 3D audio scene, wherein the resulting modified spatial volume 203 is a reduced spatial volume compared to the first spatial volume 202. While the volume fraction of the reduced spatial volume associated with the modified 3D audio scene is generally not limited, in an embodiment, the volume fraction of the reduced spatial volume associated with the modified 3D audio scene may be of from 1% to 99% with respect to the first spatial volume, preferably 10% to 80%, and more preferably 25% to 60%.

Turning to the example of FIG. 3, extending of the original 3D audio scene as a further way of modifying the original 3D audio scene is illustrated. The extending is performed by mapping the first spatial volume 302 to a second spatial volume 303 associated with the modified 3D audio scene, wherein the resulting modified spatial volume 303 is an extended spatial volume compared to the first spatial volume 302. While also the volume fraction of the extended spatial volume associated with the modified 3D audio scene is generally not limited, in an embodiment, the volume fraction of the extended spatial volume associated with the modified 3D audio scene may be of from 101% to 300% with respect to the first spatial volume, preferably 150% to 250%, and more preferably 175% to 225%.

The region to reduce or extend the original scene to may, for example, be represented by a set of coordinates relative to the coordinate system of the original 3D audio scene and/or a shape of the modified 3D audio scene, indicating a reduced or extended region/volume in 3D audio space as compared to the original 3D audio scene. After a given magnitude of reduction or extension, a respective renderer may use the reduced or extended space to render the modified 3D audio scene.

In general, modification of the original 3D audio scene to obtain a modified 3D audio scene is not limited. Some examples for performing the modification are given below:
1. Dividing the 3D audio space (e.g., represented as cube) into octants and re-directing the center of gravity of the first (original) spatial volume for rendering the original 3D audio scene to the center of one octant, with an indication of the size (extended or reduced) of the resulting second (modified) spatial volume;
2. Shifting the first spatial volume associated with the original 3D audio scene to the opposite direction in 3D audio space, reference point may be the center of the first spatial volume associated with the original 3D audio scene/center of the 3D audio space represented as cube, compared to the location where the second audio elements shall be inserted including an indication of the distance in coordinate scope of the original 3D audio scene;
3. Shifting the first spatial volume associated with the original 3D audio scene on a horizontal flat plain (2D) to the opposite direction relative to the (2D) center of the first spatial volume associated with the original 3D audio scene/center of the 3D audio space represented as cube compared to the location where the second audio elements shall be inserted including an indication of the distance;
4. Keeping the first spatial volume associated with the original 3D audio scene in the middle of the 3D audio space represented as cube, removing/attenuating first audio elements that are in the way of the second audio elements to be placed within a radius x around the second audio element location (e.g., third spatial volume);
5. Keeping the first spatial volume associated with the original 3D audio scene in the middle of the 3D audio space represented as cube, warping first audio elements from the original 3D audio scene around a volume having the shape of a cylinder/cone with an orientation towards the center of the first spatial volume (e.g., a sphere) with a radius of x in coordinate scope of the original 3D audio scene to the side—to free up the space/volume in the cylinder/cone.

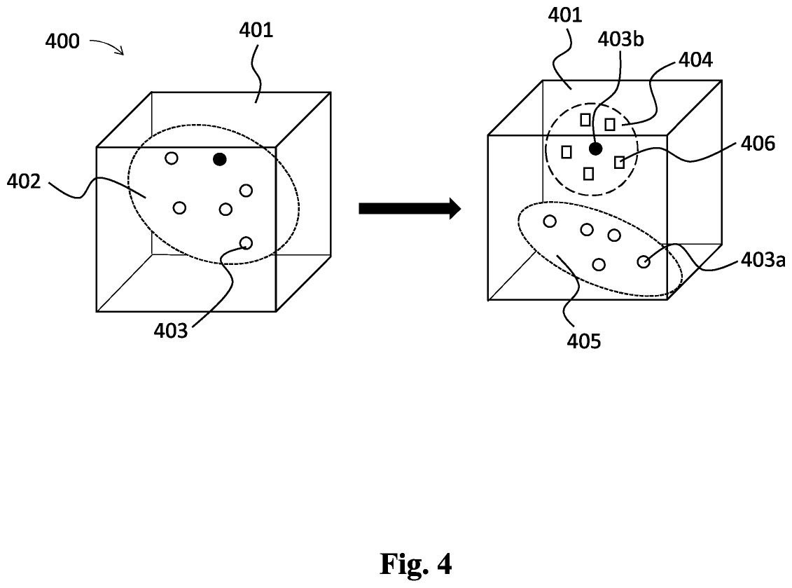

Referring to the example of FIG. 4, a further example of modifying an original 3D audio scene 400 to obtain a modified 3D audio scene and jointly rendering second audio elements and the modified 3D audio scene is illustrated. The example of FIG. 4, in a similar manner as FIG. 2, illustrates the modification of the original 3D audio scene in 3D audio space 401 by mapping the first spatial volume 402 to a second spatial volume 405 associated with the modified 3D audio scene, wherein the resulting modified spatial volume 405 is a reduced spatial volume compared to the first spatial volume 402. In addition, the example of FIG. 4 further illustrates the first spatial volume 402 to enclose a plurality of first audio elements 403.

In an embodiment, the first metadata may include first tagging information for the plurality of first audio elements indicating whether respective first audio elements are to be moved in 3D audio space when mapping the first spatial volume to the second spatial volume. Then, only first audio elements that are indicated by the first tagging information as not to be moved are rendered at their original positions.

Referring again to the example of FIG. 4, the filled circle illustrates a first audio element that is indicated by the first tagging information as not to be moved and is rendered at its original positions 403b after the modifying. Accordingly, the empty circles illustrate first audio elements 403a that are indicated by the first tagging information as to be moved and which are not rendered at their original positions 403a after the modifying, but are rendered within the modified/reduced spatial volume 405.

Notably, while the example of FIG. 4 illustrates reduction/collapsing of the first spatial volume, similar considerations apply to the extending of the first spatial volume during modification of the original 3D audio scene. That is, the methods described herein provide the capability to remove tagged audio elements that may be tagged as, for example, being of lower relevance or of a certain category with accompanying metadata and to omit audio elements from manipulation that are marked accordingly with accompanying metadata.

While in general performing the mapping the first spatial volume to the second is not limited, in an embodiment, mapping the first spatial volume to the second spatial volume may be performed instantaneously. Alternatively, mapping the first spatial volume to the second spatial volume may be performed gradually or stepwise over time. In other words, the mapping may be performed either in a direct manner, or alternatively in a slowly scaled/graceful manner.

Referring again to the examples of FIGS. 2 and 3, modifying the original 3D audio scene may further include selecting a third spatial volume 204, 304 in the 3D audio space 201, 301 for allocating the one or more second audio elements. The third spatial volume 204, 304 may at least partly overlap with the first spatial volume as illustrated, for example, in FIG. 3. Referring to the examples of FIGS. 1 to 3, jointly rendering the one or more second audio elements and the modified 3D audio scene may include rendering the one or more second audio elements within the third spatial volume 204, 304 and rendering the modified 3D audio scene within the second spatial volume 203, 303.

Referring to the example of FIG. 4, mapping the first spatial volume 402 to the second spatial volume 405 may include removing respective first audio elements 403 from the third spatial volume 404. As described earlier, only first audio elements that are indicated by the first tagging information as not to be moved 403b are not removed from the third spatial volume 404. This ensures that audio elements of higher relevance or of a certain category are not moved.

While in general performing the removing of the first audio elements from the third spatial volume is not limited, in an embodiment, removing the first audio elements from the third spatial volume may be performed instantaneously. Alternatively, removing the first audio elements from the third spatial volume may be performed gradually or stepwise over time.

Referring again to the examples of FIG. 2 to FIG. 4, while the shape of the respective spatial volumes is illustrated to be elliptical or spherical, the shape of the first, the second and/or the third spatial volume is generally not limited. In an embodiment, however, the shape of the first, the second, and/or the third spatial volume may include one or more of a sphere, a quadrant, an octant, and a point. The shape of the first, the second, and/or the third spatial volume may be based on the metadata, or, alternatively, may be predefined.

Referring to the examples of FIG. 1 to FIG. 4, modifying the original 3D audio scene and/or the joint rendering may be based on first timing information. The first timing information may indicate a point in time or a time period for applying said modifying and/or said joint rendering.

As described above, methods and apparatuses as described herein enable to temporarily influence and manipulate an original immersive rendered audio scene. In an embodiment, the method may thus further include, following the joint rendering, removing the one or more second audio elements and returning to rendering the original 3D audio scene. Removing the one or more second audio elements and/or the returning to the rendering of the original 3D audio scene may be based on second timing information. The second timing information may indicate a point in time or a time period for applying said removing and/or said returning.

In a similar manner as for the first audio elements, the second metadata may include second tagging information for the one or more second audio elements indicating whether respective second audio elements are to be removed when returning to the rendering of the original 3D audio scene. Then, only second audio elements that are indicated by the second tagging information as not to be removed are not removed prior to the rendering of the original 3D audio scene.

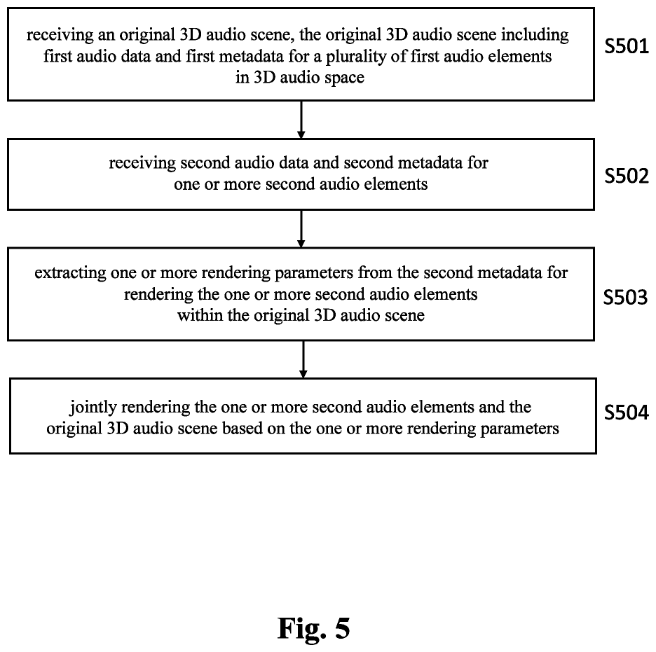

Referring now to FIG. 5, a second example of a method of processing a 3D audio scene 500 is illustrated. In contrast to the first example, in this case, the original 3D audio scene is left unmodified.

In step S501, an original 3D audio scene is received. The original 3D audio scene includes first audio data and first metadata for a plurality of first audio elements in 3D audio space.

In step S502, second audio data and second metadata for one or more second audio elements are received.

In step S503, one or more rendering parameters are extracted from the second metadata for rendering the one or more second audio elements within the original 3D audio scene.

And in step S504, the one or more second audio elements and the original 3D audio scene are jointly rendered based on the one or more rendering parameters.

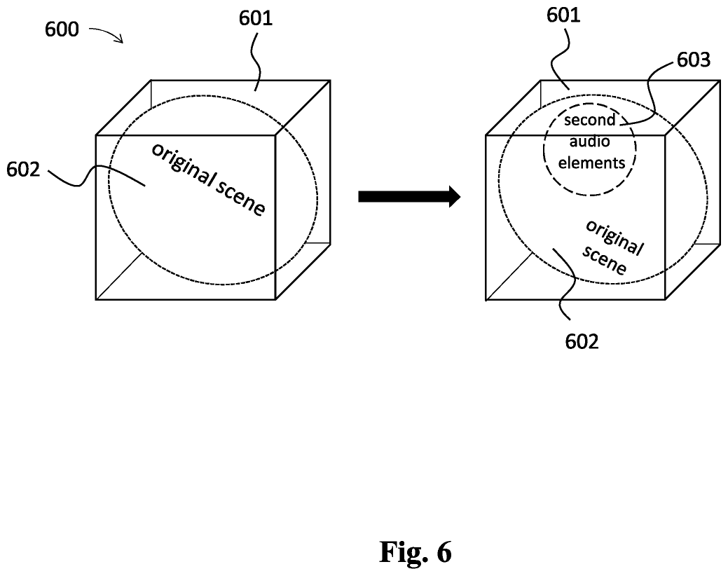

Referring to FIG. 6, a schematic of an example of jointly rendering second audio elements and an original 3D audio scene 600 is illustrated. In a similar manner as in the examples of FIG. 2 and FIG. 3, the original 3D audio scene is illustrated in 3D audio space 601 to be associated with a respective (first) spatial volume 602. This first spatial volume 602 may also in this example enclose a respective plurality of first audio elements which are not illustrated for reasons of simplicity. In the present example, the joint rendering may include embedding 603 the one or more second audio elements into the original 3D audio scene 602 such that the original 3D audio scene is augmented by the one or more second audio elements. The joint rendering may further include modifying some or all of the first audio elements based on the one or more rendering parameters as described herein.

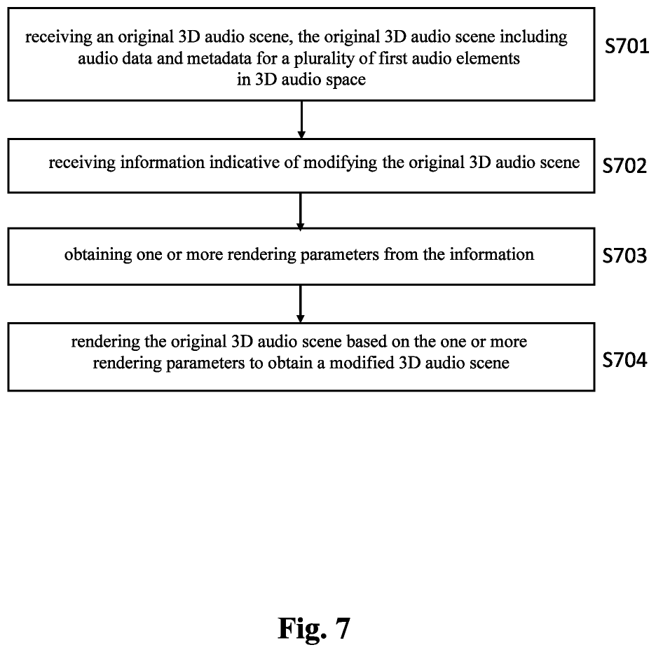

Referring now to FIG. 7, a third example of a method of processing a 3D audio scene 700 is illustrated. In this case, only the original 3D audio scene is modified.

In step S701, an original 3D audio scene is received, the original 3D audio scene includes audio data and metadata for a plurality of first audio elements in 3D audio space.

The metadata may define specific properties for each of the plurality of first audio elements. An example for a specific property may be tagging information. The tagging information may indicate for each of the plurality of first audio elements whether they are modifiable when the original 3D audio scene should be modified. In other words, the tagging information may protect a specific audio element out of the plurality of first audio elements from being modified based on some or any received indication for modifying the original 3D audio scene.

In step S702, information indicative of modifying the original 3D audio scene is received. In an embodiment, the information may correspond to default metadata associated with one or more default audio elements. Default audio elements may be said to be empty, the rendering of which results only in modification. Alternatively, the information may be real-time generated information. Yet alternatively, the information may be based on user preferences and/or location data.

In some embodiments, the information may be received from a user, for example, via an interface. Alternatively, the information may be part of a bitstream, which has been received over a network.

The user preferences may include user-specific sensory impairments and sensory preferences of a user, in order to improve the original 3D audio scene for the specific sensory impairment or the sensory preference. The sensory impairments may specifically relate to hearing abilities such as a partial hearing loss on both ears, or a complete hearing loss on one ear. A partial hearing loss may relate to a hearing loss in a specific frequency range. For example, the information may indicate an age dependent hearing loss, which may correspond to a hearing loss for frequencies above 2 kHz.

In Step S703, one or more rendering parameters are obtained from the information.

The rendering parameters may include a parameter for attenuating early reflections, a parameter for reverberation attenuation, and/or a parameter for expansion/compression of a distance-dependent gain.

Further, the rendering parameters may include one or more parameters for rendering the original 3D audio scene with a directional focus. A directional focus may be understood as focusing the attention of the user in a certain direction by amplifying audio elements in the direction or by attenuating elements that are outside of the direction. Amplification or attenuation of audio elements may increase/decrease gradually for a specific distance or angle deviating from the direction. The direction may be a viewing direction of the user. In other words, a default direction steers towards the frontal viewing direction of the user, but can also be reorientated to other directions to enable control through other services or modalities (e.g., eye tracker). Optionally, audio elements that are authored to be in the user's coordinate system are associated with the listener and will not be processed with the directional focus.

The one or more parameters for rendering the original 3D audio scene with the directional focus may comprise a flag for indicating whether the directional focus should be applied to the original 3D audio scene, an angular range corresponding to the viewing direction, a transition angle for the gradual attenuation, a maximum attenuation, a flag for indicating a default direction for the directional focus, a yaw angle for indicating the viewing direction, and a pitch angle for indicating the viewing direction.

As an example, when the received information indicates a partial hearing loss, the obtained rendering parameter may be the parameter for reverb attenuation. By rendering the original audio scene with attenuated reverb, the intelligibility for users with a partial hearing loss may be greatly increased. Additionally, a sensory overload may be reduced for the user, if the reverb is attenuated or the early reflections are attenuated.

And in step S704, the original 3D audio scene is rendered based on the one or more rendering parameters to obtain a modified 3D audio scene.

In other words, the original 3D audio scene is rendered with modified rendering parameters instead of the default rendering parameters such that the modified 3D audio scene is rendered. As an example, audio elements outside of a directional focus may be rendered with an attenuation gain such that the modified 3D audio scene corresponds to the original 3D audio scene but with a directional focus. In other words, the user may perceive audio elements in a viewing direction as amplified.

In some embodiments, in which the metadata includes tagging information for each of the plurality of first audio elements, specific audio elements are rendered with the default rendering parameters instead of the rendering parameters obtained from the received information, if the tagging information indicates that the specific audio elements should be left unmodified. Optionally, the tagging information may prohibit any modification or only specific modifications, such as modification due to a directional focus, rendering with a distance-dependent gain, or rendering with new coordinates in the 3D space.

Further, when the received information provides information that the user suffers under a spectral hearing loss, the rendering of the original 3D audio may include a dynamic equalization for compensating the spectral hearing loss for both ears individually.

By accounting for user-preferences directly within the rendering system, the performance and quality of modifying the 3D audio scene can be improved, because of the ability to optimize the audio rendition on-the-fly.

In some embodiments, the original 3D audio scene may be rendered by any one of a speaker, binaural headphones, a VR headset or any other suitable device for rendering 3D audio.

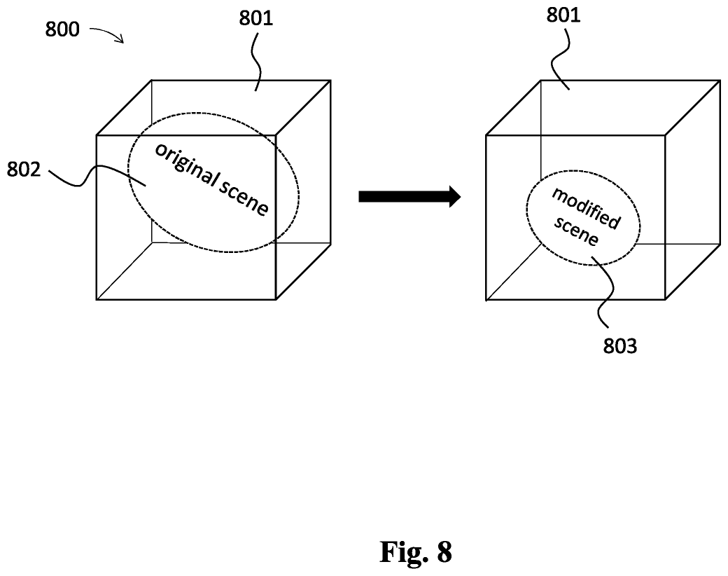

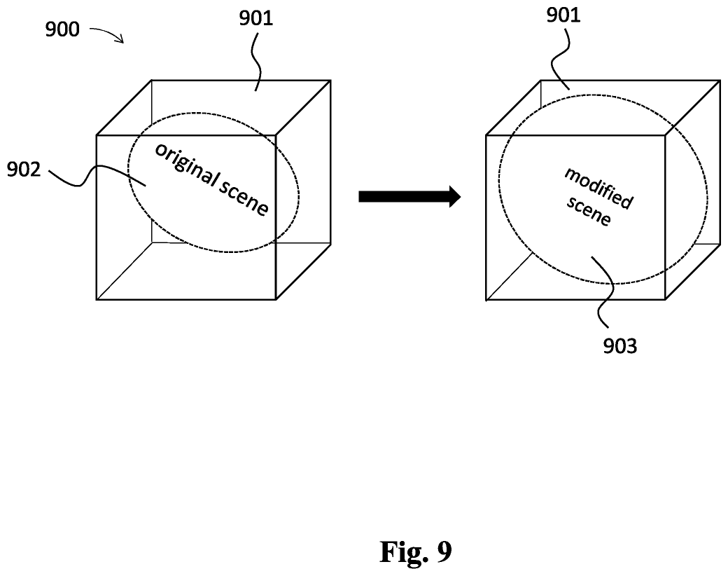

Referring to FIG. 8 and FIG. 9, schematics of examples of modifying an original 3D audio scene to obtain a modified 3D audio scene 800, 900 are illustrated. In a similar manner as in the examples of FIG. 2 and FIG. 3, the original 3D audio scenes are illustrated in 3D audio space 801, 901 to be associated with respective (first) spatial volumes 802, 902. This first spatial volume 802, 902 may also in this example enclose a respective plurality of first audio elements which are not illustrated for reasons of simplicity. In a similar manner as already described, rendering the original 3D audio scene based on the one or more rendering parameters to obtain a modified 3D audio scene may include mapping the first spatial volume to a second spatial volume associated with the modified 3D audio scene, where the second spatial volume may be a modified spatial volume compared to the first spatial volume.

Referring to the example of FIG. 8, collapsing the original 3D audio scene by mapping the first spatial volume 802 to a second spatial volume 803 associated with the modified 3D audio scene is illustrated, wherein the resulting modified spatial volume 803 is a reduced spatial volume compared to the first spatial volume 802. While the volume fraction of the reduced spatial volume associated with the modified 3D audio scene is generally not limited, in an embodiment, the volume fraction of the reduced spatial volume associated with the modified 3D audio scene may be of from 1% to 99% with respect to the first spatial volume, preferably 10% to 80%, and more preferably 25% to 60%.

Turning to the example of FIG. 9, extending the original 3D audio scene is illustrated. The extending is performed by mapping the first spatial volume 902 to a second spatial volume 903 associated with the modified 3D audio scene, wherein the resulting modified spatial volume 903 is an extended spatial volume compared to the first spatial volume 902. While also the volume fraction of the extended spatial volume associated with the modified 3D audio scene is generally not limited, in an embodiment, the volume fraction of the extended spatial volume associated with the modified 3D audio scene may be of from 101% to 300% with respect to the first spatial volume, preferably 150% to 250%, and more preferably 175% to 225%.

### Parameters

In addition to the above, the manipulation/modification of the original 3D audio scene and/or the joint rendering may further be steered based on the following parameters applied alone or in combination depending on respective use cases.

In an embodiment, the one or more rendering parameters may include an indication of a loudness of the one or more second audio elements, and the joint rendering may further include adjusting the loudness of the one or more second audio elements relative to a loudness of the modified 3D audio scene.

In an embodiment, the joint rendering may further include adapting a gain of the modified 3D audio scene and/or of the one or more second audio elements.

In an embodiment, the method may further include receiving different versions of the second audio data for the one or more second audio elements, each version having a different audio configuration. The method may then further include selecting a version of the second audio data for the one or more second audio elements that best matches the audio configuration of the original 3D audio scene.

In an embodiment, the joint rendering may further include aligning the audio configurations of the one or more second audio elements and the modified 3D audio scene.

In an embodiment, the one or more rendering parameters may further include an indication of a perceived complexity of the one or more second audio elements.

In an embodiment, the one or more rendering parameters may further include an indication of a sensitivity with respect to a perceived interference of the one or more second audio elements by other audio elements.

In an embodiment, the one or more rendering parameters may further include an indication of an audio quality of the one or more second audio elements. The method may then further include, prior to the joint rendering, comparing the audio quality of the one or more second audio elements to an audio quality of the original 3D audio scene and aligning the audio quality of the one or more second audio elements with the audio quality of the original 3D audio scene. An example for an indication of an audio quality may be bit rate of the streams, specifically if there are quality plateaus. If the original 3D audio scene is from bit rate plateau=3, a decision logic may decide to fetch the second audio elements, accordingly, from the same bit rate plateau.

In an embodiment, the one or more rendering parameters may further include an indication of a priority level for each of the one or more second audio elements, the priority level indicating a priority for rendering a respective second audio element. The joint rendering may then further include modifying some or all of the first audio elements based on the respective priority levels.

In an embodiment, the one or more rendering parameters may further include an indication of a category for each of the one or more second audio elements, the category including one or more of optional, mandatory, supplemental, emergency, dependent on, depending on, in context of the original 3D audio scene and out of context of the original 3D audio scene.

In an embodiment, the joint rendering may be based on the perceived complexity and/or the sensitivity of the original 3D audio scene and optionally be based on the indication of the perceived complexity and/or the indication of the sensitivity of the one or more second audio elements.

In an embodiment, the joint rendering may be based on the indication of the priority level and the indication of the category of each of the one or more second audio elements, disregarding the perceived complexity and the sensitivity of the original 3D audio scene.

In an embodiment, the selecting the third spatial volume or a prioritizing of the allocating of the one or more second audio elements to the third spatial volume may be based on one or more of the indication of the perceived complexity, the sensitivity, the audio quality, the priority level and the category of the one or more second audio elements.

In an embodiment, a first audio element of the original 3D audio scene relating to ambience within the third spatial volume may be left unmodified and the joint rendering may include attenuating or amplifying the one or more second audio elements relative to the first audio element relating to ambience.

In other words, parameters available to steer the manipulation/modification of the original 3D audio scene and the joint rendering of the one or more second audio elements may be:
1. [XYZ] 3D coordinates within the original scene to collapse to
2. [INT] size of target shape in %, or other indication of a fraction of the original size, or the region of the collapse (e.g. indication of one or more octants, quadrants)
3. [XYZ] 3D coordinates in the original scene that shall be cleared of audio elements that belong to the host scene (first audio elements)
4. [INT] size of shape to free up in %, or other indication of a fraction of the host scene size, or other indication of the region to free up (e.g. octants, quadrant)
5. [INT] indication of loudness of host scene and guest elements (second audio elements)
6. [INT] indication of the experiential complexity of the audio elements (host scene, guest element)
7. [INT] indication of the sensitivity of the audio elements (host scene, guest elements)
8. [INT] indication of the audio quality of the audio elements (host scene, guest elements)
9. [INT] priority level of the audio elements (host scene, guest elements)
10. [table] category of guest audio element (e.g. optional, supplemental, mandatory, emergency, dependent on, depending on, in context of host scene, out of context of host scene)
11. [INT] gain adaptation for host scene or guest audio elements
12. [TIME] timing information for when to apply the change (absolute/UTC, relative to host timeline)
13. [INT] indication that the host audio scene or any guest element may, should, shall or shall not be omitted from manipulation
14. [FLOAT] amount of early reflection level reduction in decibel
15. [FLOAT] amount of reverb level reduction in decibel
16. [BIN] flag to indicate if a distance exponent is enabled
17. [FLOAT] parameter for exponentially modifying (i.e., shrinking or expanding) the distance value r of the rendering items which are fed to the distance-dependent gain computation
18. [BIN] flag to indicate if the directional focus is enabled
19. [INT] radius of a main lobe in degree of the directional focus
20. [INT] width of the transition region between the main lobe and a stopband in degree
21. [FLOAT] directional gain reduction in the stopband in decibel
22 [BIN] flag to indicate if the directional focus has a non-default direction
23. [INT] yaw angle of the primary direction of the directional focus with respect to a frontal head orientation
24. [INT] pitch angle of the primary direction of the directional focus with respect to a frontal head orientation
25. [BIN] if this authoring parameter is set, the specific element is never processed with the directional focus effect
A. Adaptation of the rendering of the host scene based on the indication of complexity & sensitivity [7] of the host scene, taking into account the complexity [6] & sensitivity [7] of the guest element to be added
B. Selection or prioritization of placement of guest elements based on the complexity [6] & sensitivity [7] & quality [8] of the rendering of the host scene
C. Selection or prioritization of placement of guest elements based on the priority [9] of the guest element
D. Selection or prioritization of placement of guest element based on the category [10] of the element
E. Allowing adaptation of the rendering of the original host scene ignoring its own indication of complexity [6] and sensitivity [7] and quality [8], but focusing on category [10] and priority [9] of the guest element
F. Selection of a proper guest element from a selection of alternatives based on the technical configuration of the host scene, i.e. its audio configuration (bit depth, sampling rate, channel/object config, loudness [5])
G. Handling or alignment (e.g. resampling, loudness adjustment) of the rendering of the host scene and the guest element, in case each one is having a dedicated/different audio configuration (bit depth, sampling rate, channel/object config, loudness [5])
H. Gradual adaptation to predefined or metadata-controlled shape [2] of the host scene and coordinates [1] (+inversive)
a. Collapse from full to a smaller shape instantaneously
b Collapse from full to a single point (mono) instantaneously
c. Collapse from full to a smaller shape gradually or in stages
d. Collapse from full to a single point (mono) gradually or in stages
e. Change from a predefined or metadata-controlled shape to another predefined or metadata-controlled shape instantaneously
f. Change from a predefined or metadata-controlled shape to another predefined or metadata-controlled shape in stages
I. Gradual adaptation to predefined or metadata-controlled shape [4] of the guest element and coordinates [3] (+inversive)
a. Expansion from null or mono to full shape instantaneously
b. Expansion from null or mono to full shape gradually or in stages
c. Change from a predefined or metadata-controlled shape to another predefined or metadata-controlled shape instantaneously
d. Change from a predefined or metadata-controlled shape to another predefined or metadata-controlled shape in stages
J. Timed [12] rendering manipulation of the host scene (collapse/expansion)
K. Timed [12] embedding and removal of guest elements
L. Omission of certain audio elements already embedded in host scene that are marked accordingly [13] from manipulation (e.g. in case there are multiple/concurrent elements to be embedded)
M. Embedding of multiple (concurrent) guest elements to augment the host scene adjustment of the collapse of the host scene may be controlled by metadata or may be predefined (e.g. apply none, select one, or apply multiple concurrent collapse directives)
N. Adjusting the host scene by moving host scene elements away from the space to be freed up, but keeping general host scene ambience (channel beds, HOA ambience) unmodified, or attenuated [11] either controlled by metadata or by predefined values.
O. Adjusting the host scene by moving host scene elements away from the space to be freed up, but keeping general host scene ambience (channel beds, HOA ambience) unmodified. Guest elements may be amplified or attenuated [11] either controlled by metadata or by predefined values.
P. Leaving the host scene unmodified. Guest elements may be amplified or attenuated [11] either controlled by metadata or by predefined values.

### Apparatus for Implementing Methods According to the Disclosure

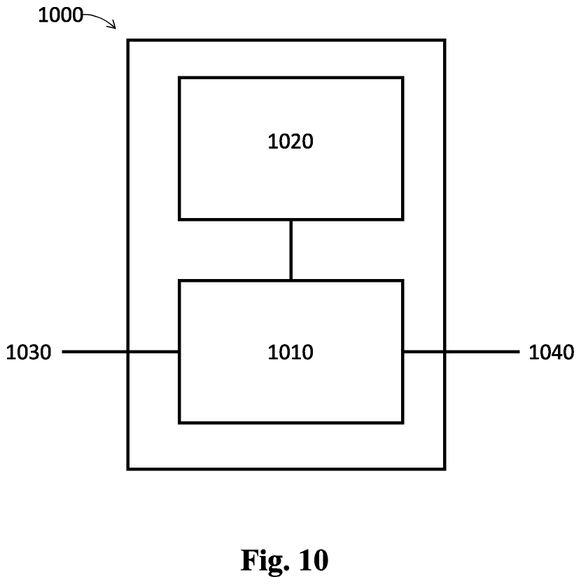

Finally, the present disclosure likewise relates to respective apparatuses (e.g., computer-implemented apparatuses) for performing methods and techniques described throughout the present disclosure. The respective apparatuses may be implemented as renderers. The renderers may be implemented on servers or on end-devices. The end-devices may be wearable devices. FIG. 10 shows an example of such an apparatus 1000. In particular, apparatus 1000 comprises a processor 1010 and a memory 1020 coupled to the processor 1010. The memory 1020 may store instructions for the processor 1010. The processor 1010 may also receive, among others, suitable input data 1030, depending on use cases and/or implementations. The processor 1010 may be adapted to carry out the methods/techniques described throughout the present disclosure and to generate corresponding output data 1040 depending on use cases and/or implementations.

### Interpretation

Aspects of the apparatuses described herein may be implemented in an appropriate computer-based sound processing network environment for processing digital or digitized audio files.

Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics.

Computer-readable media in which such formatted data and/or instructions may be embodied include, but are not limited to, physical (non-transitory), non-volatile storage media in various forms, such as optical, magnetic or semiconductor storage media.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art.

### Enumerated Example Embodiments

Aspects and implementations of the present disclosure may also be appreciated from the following enumerated example embodiments, which are not claims.
EEE1. A method of processing a 3D audio scene, the method including:
receiving an original 3D audio scene, the original 3D audio scene including first audio data and first metadata for a plurality of first audio elements in 3D audio space;
receiving second audio data and second metadata for one or more second audio elements;
extracting one or more rendering parameters from the second metadata for rendering the one or more second audio elements relative to the original 3D audio scene;
modifying the original 3D audio scene to obtain a modified 3D audio scene; and
jointly rendering the one or more second audio elements and the modified 3D audio scene based on the one or more rendering parameters.
EEE2. The method of EEE1, wherein modifying the original 3D audio scene is based on the metadata.
EEE3. The method of EEE1 or 2, wherein the original 3D audio scene is associated with a first spatial volume that encloses the plurality of first audio elements, and wherein modifying the original 3D audio scene includes mapping the first spatial volume to a second spatial volume associated with the modified 3D audio scene, where the second spatial volume is a modified spatial volume compared to the first spatial volume.
EEE4. The method of EEE3, wherein the modified spatial volume is a reduced spatial volume, and wherein optionally a volume fraction of the reduced spatial volume associated with the modified 3D audio scene is of from 1% to 99% with respect to the first spatial volume.
EEE5. The method of EEE3, wherein the modified spatial volume is an extended spatial volume, and wherein optionally a volume fraction of the extended spatial volume associated with the modified 3D audio scene is of from 101% to 300% with respect to the first spatial volume.
EEE6. The method of any of EEEs 3 to 5, wherein the first metadata includes first tagging information for the plurality of first audio elements indicating whether respective first audio elements are to be moved in 3D audio space when mapping the first spatial volume to the second spatial volume, and wherein only first audio elements that are indicated by the first tagging information as not to be moved are rendered at their original positions.
EEE7. The method of any of EEEs 3 to 6, wherein mapping the first spatial volume to the second spatial volume is performed instantaneously.
EEE8. The method of any of EEEs 3 to 6, wherein mapping the first spatial volume to the second spatial volume is performed gradually or stepwise over time.
EEE9. The method of any of EEEs 3 to 8, wherein modifying the original 3D audio scene further includes selecting a third spatial volume in the 3D audio space for allocating the one or more second audio elements.
EEE10. The method of EEE9, wherein the third spatial volume is at least partly overlapping with the first spatial volume.
EEE 11. The method of EEE9 or 10 in dependence on EEE6, wherein mapping the first spatial volume to the second spatial volume includes removing respective first audio elements from the third spatial volume, and wherein only first audio elements that are indicated by the first tagging information as not to be moved are not removed from the third spatial volume.
EEE12. The method of EEE11, wherein removing the first audio elements from the third spatial volume is performed instantaneously.
EEE13. The method of EEE11, wherein removing the first audio elements from the third spatial volume is performed gradually or stepwise over time.
EEE14. The method of EEEs 9 to 13, wherein jointly rendering the one or more second audio elements and the modified 3D audio scene includes rendering the one or more second audio elements within the third spatial volume and rendering the modified 3D audio scene within the second spatial volume.
EEE15. The method of any of EEEs 3 to 14, wherein a shape of the first, the second, and/or the third spatial volume includes one or more of a sphere, a quadrant, an octant, and a point.
EEE16. The method of EEE15, wherein the shape of the first, the second, and/or the third spatial volume is based on the metadata.
EEE17. The method of EEE15, wherein the shape of the first, the second, and/or the third spatial volume is predefined.
EEE18. The method of any of EEEs 1 to 17, wherein the modifying the original 3D audio scene and/or the joint rendering is based on first timing information, the first timing information indicating a point in time or a time period for applying said modifying and/or said joint rendering.
EEE19. The method of any of EEEs 1 to 18, wherein the method further includes, following the joint rendering, removing the one or more second audio elements and returning to rendering the original 3D audio scene.
EEE20. The method of EEE19, wherein the removing the one or more second audio elements and/or the returning to the rendering of the original 3D audio scene is based on second timing information, the second timing information indicating a point in time or a time period for applying said removing and/or said returning.

EEE 21. The method of EEE 19 or 20, wherein the second metadata includes second tagging information for the one or more second audio elements indicating whether respective second audio elements are to be removed when returning to the rendering of the original 3D audio scene, and wherein only second audio elements that are indicated by the second tagging information as not to be removed are not removed prior to the rendering of the original 3D audio scene.
EEE22. The method of any of EEEs 1 to 21, wherein the one or more rendering parameters include an indication of a loudness of the one or more second audio elements, and wherein the joint rendering further includes adjusting the loudness of the one or more second audio elements relative to a loudness of the modified 3D audio scene.
EEE23. The method of any of EEEs 1 to 22, wherein the joint rendering further includes adapting a gain of the modified 3D audio scene and/or of the one or more second audio elements.
EEE24. The method of any of EEEs 1 to 23, wherein the method includes receiving different versions of the second audio data for the one or more second audio elements, each version having a different audio configuration.
EEE25. The method of EEE24, wherein the method further includes selecting a version of the second audio data for the one or more second audio elements that best matches the audio configuration of the original 3D audio scene.
EEE26. The method of EEE 24 or 25, wherein the joint rendering further includes aligning the audio configurations of the one or more second audio elements and the modified 3D audio scene.
EEE27. The method of any of EEEs 1 to 26, wherein the one or more rendering parameters further include an indication of a perceived complexity of the one or more second audio elements.
EEE28. The method of any of EEEs 1 to 27, wherein the one or more rendering parameters further include an indication of a sensitivity with respect to a perceived interference of the one or more second audio elements by other audio elements.
EEE29. The method of any of EEEs 1 to 28, wherein the one or more rendering parameters further include an indication of an audio quality of the one or more second audio elements.
EEE30. The method of EEE29, wherein the method further includes, prior to the joint rendering, comparing the audio quality of the one or more second audio elements to an audio quality of the original 3D audio scene and aligning the audio quality of the one or more second audio elements with the audio quality of the original 3D audio scene.
EEE31. The method of any of EEEs 1 to 30, wherein the one or more rendering parameters further include an indication of a priority level for each of the one or more second audio elements, the priority level indicating a priority for rendering a respective second audio element.
EEE32. The method of EEE31, wherein the joint rendering further includes modifying some or all of the first audio elements based on the respective priority levels.
EEE33. The method of any of EEEs 1 to 32, wherein the one or more rendering parameters further include an indication of a category for each of the one or more second audio elements, the category including one or more of optional, mandatory, supplemental, emergency, dependent on, depending on, in context of the original 3D audio scene and out of context of the original 3D audio scene.

EEE 34. The method of EEE 27 or 28, wherein the joint rendering is based on the perceived complexity and/or the sensitivity of the original 3D audio scene and optionally based on the indication of the perceived complexity and/or the indication of the sensitivity of the one or more second audio elements.
EEE35. The method of EEE34 in dependence on EEE31, wherein the joint rendering is based on the indication of the priority level and the indication of the category of each of the one or more second audio elements, disregarding the perceived complexity and the sensitivity of the original 3D audio scene.
EEE36. The method of EEEs 27, 28, 29, 31 and/or 33 in dependence on EEE9 or 10, wherein the selecting the third spatial volume or a prioritizing of the allocating of the one or more second audio elements to the third spatial volume is based on one or more of the indication of the perceived complexity, the sensitivity, the audio quality, the priority level and the category of the one or more second audio elements.
EEE37. The method of any of EEEs 9 to 36, wherein a first audio element of the original 3D audio scene relating to ambience within the third spatial volume is left unmodified and the joint rendering includes attenuating or amplifying the one or more second audio elements relative to the first audio element relating to ambience.
EEE38. A method of processing a 3D audio scene, the method including:
receiving an original 3D audio scene, the original 3D audio scene including first audio data and first metadata for a plurality of first audio elements in 3D audio space;
receiving second audio data and second metadata for one or more second audio elements;
extracting one or more rendering parameters from the second metadata for rendering the one or more second audio elements within the original 3D audio scene; and
jointly rendering the one or more second audio elements and the original 3D audio scene based on the one or more rendering parameters.
EEE39. The method of EEE38, wherein the joint rendering includes embedding the one or more second audio elements into the original 3D audio scene such that the original 3D audio scene is augmented by the one or more second audio elements.
EEE40. The method of EEE 38 or 39, wherein the joint rendering includes modifying some or all of the first audio elements based on the one or more rendering parameters.
EEE41. A method of processing a 3D audio scene, the method including:
receiving an original 3D audio scene, the original 3D audio scene including audio data and metadata for a plurality of first audio elements in 3D audio space;
receiving information indicative of modifying the original 3D audio scene;
obtaining one or more rendering parameters from the information; and
rendering the original 3D audio scene based on the one or more rendering parameters to obtain a modified 3D audio scene.
EEE42. The method of EEE41, wherein the information corresponds to default metadata associated with one or more default audio elements.
EEE43. The method of EEE41, wherein the information is real-time generated information. EEE44. The method of EEE41, wherein the information is based on user preferences and/or location data.
EEE45. An apparatus for processing an audio scene, the apparatus including one or more processors configured to carry out a method including:
receiving an original 3D audio scene, the original 3D audio scene including first audio data and first metadata for a plurality of first audio elements in 3D audio space;
receiving second audio data and second metadata for one or more second audio elements;
extracting one or more rendering parameters from the second metadata for rendering the second audio elements relative to the original 3D audio scene;
modifying the original 3D audio scene to obtain a modified 3D audio scene; and jointly rendering the one or more second audio elements and the modified 3D audio scene based on the one or more rendering parameters.
EEE46. The apparatus of EEE45, wherein the one or more processors are further configured to remove, after the joint rendering, the one or more second audio elements and to return to rendering the original 3D audio scene.
EEE47. An apparatus for processing an audio scene, the apparatus including one or more processors configured to carry out a method including:
receiving an original 3D audio scene, the original 3D audio scene including first audio data and first metadata for a plurality of first audio elements in 3D audio space;
receiving second audio data and second metadata for one or more second audio elements;
extracting one or more rendering parameters from the second metadata for rendering the one or more second audio elements within the original 3D audio scene; and
jointly rendering the one or more second audio elements and the original 3D audio scene based on the one or more rendering parameters.
EEE48. An apparatus for processing an audio scene, the apparatus including one or more processors configured to carry out a method including:
receiving an original 3D audio scene, the original 3D audio scene including audio data and metadata for a plurality of first audio elements in 3D audio space;
receiving information indicative of modifying the original 3D audio scene;
obtaining one or more rendering parameters from the information; and
rendering the original 3D audio scene based on the one or more rendering parameters to obtain a modified 3D audio scene.
EEE49. A program comprising instructions that, when executed by a processor, cause the processor to carry out the method according to any one of EEEs 1 to 44.
EEE50. A computer-readable storage medium storing the program according to EEE49.

1. A method of processing a 3D audio scene, the method including:
receiving an original 3D audio scene, the original 3D audio scene including audio data and metadata for a plurality of first audio elements in 3D audio space;
receiving information indicative of modifying the original 3D audio scene;
obtaining one or more rendering parameters from the information; and
rendering the original 3D audio scene based on the one or more rendering parameters to obtain a modified 3D audio scene.

2. The method of claim 1, wherein rendering the original 3D audio scene is further based on the metadata.

3. The method of claim 1, wherein the metadata comprises tagging information for the plurality of first audio elements indicating whether respective first audio elements are to be modified when rendering the original 3D audio scene.

4. The method of claim 1, wherein the information is based on user preferences and/or location data.

5. The method of claim 4, wherein the user preferences comprise user-specific sensory impairments and/or sensory preferences of a user.

6. The method of claim 5, wherein the user-specific sensory impairments comprise hearing abilities.

7. The method of claim 6, wherein the hearing abilities comprise a spectral hearing loss and wherein rendering the original 3D audio scene based on the one or more rendering parameters to obtain the modified 3D audio scene comprises a dynamic equalization for compensating the spectral hearing loss for both ears individually.

8. The method of claim 5, wherein the sensory preferences of the user comprise improved intelligibility, and/or reduced sensory overload.

9. The method of claim 3, wherein the rendering parameters comprise a parameter for attenuating early reflections, a parameter for reverberation attenuation, and/or a parameter for expansion/compression of a distance-dependent gain.

10. The method of claim 1, wherein the rendering further includes adapting a gain of the original 3D audio scene.

11. The method of claim 10 when depending on claim 9, wherein the gain of the original 3D audio scene is the distance-dependent gain.

12. The method of claim 11, wherein the tagging information indicates whether respective first audio elements are to be rendered with the distance-dependent gain.

13. The method of claim 1, wherein the rendering parameters comprise one or more parameters for rendering the original 3D audio scene with a directional focus.

14. The method of claim 13, wherein the directional focus attenuates sound outside of a viewing direction of a user.

15. The method of claim 14, wherein the attenuating of sound outside of the viewing direction of the user is a gradual attenuation.

16. The method of claim 15, wherein the one or more parameters for rendering the original 3D audio scene with the directional focus comprise a flag for indicating whether the directional focus should be applied to the original 3D audio scene, an angular range corresponding to the viewing direction, a transition angle for the gradual attenuation, a maximum attenuation, a flag for indicating a default direction for the directional focus, a yaw angle for indicating the viewing direction, and/or a pitch angle for indicating the viewing direction.

17. The method of claim 13 when depending on claim 3, wherein the tagging information indicates whether respective first audio elements are to be rendered with the directional focus.

18-68. (canceled)

69. An apparatus for processing an audio scene, the apparatus including one or more processors configured to carry out a method including:
receiving an original 3D audio scene, the original 3D audio scene including first audio data and first metadata for a plurality of first audio elements in 3D audio space;
receiving second audio data and second metadata for one or more second audio elements;
extracting one or more rendering parameters from the second metadata for rendering the second audio elements relative to the original 3D audio scene;
modifying the original 3D audio scene to obtain a modified 3D audio scene; and
jointly rendering the one or more second audio elements and the modified 3D audio scene based on the one or more rendering parameters;
wherein modifying the original 3D audio scene is based on the metadata.

70-71. (canceled)

72. An apparatus for processing an audio scene, the apparatus including one or more processors configured to carry out a method including:
receiving an original 3D audio scene, the original 3D audio scene including audio data and metadata for a plurality of first audio elements in 3D audio space;
receiving information indicative of modifying the original 3D audio scene;
obtaining one or more rendering parameters from the information; and
rendering the original 3D audio scene based on the one or more rendering parameters to obtain a modified 3D audio scene.

73. A non-transitory program comprising instructions that, when executed by a processor, cause the processor to carry out the method according to claim

74. (canceled)
